(19) United States
(12) Patent Application Publication
(10) Pub. No.: US 2026/0133321 A1
(43) Pub. Date: May 14, 2026

(54) SIGNAL PROCESSING DEVICE AND METHOD FOR HIGH-RESOLUTION MULTI-CHANNEL 3D LIDAR

(71) Applicant: KOREA ELECTRONICS TECHNOLOGY INSTITUTE, Seongnam-si (KR)

(72) Inventors: Sang Gyun GI, Gwangju (KR); Seung Joo LEE, Jeongeup-si (KR); Yong Hwi KIM, Gwangju (KR); Ji Hyuk CHO, Gwangju (KR); Jun Seop LEE, Seoul (KR)

(21) Appl. No.: 19/386,951

(22) Filed: Nov. 12, 2025

(30) Foreign Application Priority Data
Nov. 13, 2024 (KR) 10-2024-0161006

(51) Int. Cl. G01S 17/894; G01S 7/481; G01S 7/4913; G01S 7/493

(52) U.S. Cl. CPC G01S 17/894; G01S 7/4817; G01S 7/4913; G01S 7/493

(57) ABSTRACT

Proposed are a signal processing device and a method for a multi-channel 3D LiDAR. The device may include a plurality of light receiving units each forming a channel. The device may also include a plurality of read-out circuit units configured to convert each light detection signal of the light receiving units into a digital signal. The device may further include a plurality of digital signal processors configured to determine and output a state of a channel selection signal according to an output of each of the read-out circuit units. The device may further include a filter unit configured to infer a scanning pattern using the channel selection signals of the digital signal processors and to filter out, as noise, light reception information of channels that differ from the scanning pattern.

### STATEMENT REGARDING GOVERNMENT SPONSORED R&D

This work was supported by the following national research and development project funded by the government of the Republic of Korea as follows:
[Assignment Unique Number] 2410000202,
[Assignment number] 00234343,
[Name of the Ministry] Ministry of Trade, Industry and Energy (Republic of Korea),
[Name of the Assignment Managing (Professional) Organization] Korea Evaluation Institute of Industrial Technology (KEIT),
[Research Project Title] Korea-led K-Sensor Technology Development (R&D) for Market Leadership,
[Assignment Title] Development of Core Optical Components for Domestic Production and Ultra-Compact Photonic Integration Module Technology for Commercialization of High-Resolution MEMS-Type 4D FMCW LiDAR for Autonomous Vehicles,
[Name of the Organization Performing the Assignment] Korea Electronics Technology Institute (KETI), and
[Research Period] Apr. 1, 2023-Dec. 31, 2027.

### CROSS-REFERENCE TO RELATED APPLICATION

The present application claims priority under 35 U.S.C. § 119 (a) to Korean patent application number 10-2024-0161006 filed on Nov. 13, 2024, in the Korean Intellectual Property Office, the entire disclosure of which is incorporated by reference herein.

### BACKGROUND

### Technical Field

The present disclosure relates to a signal processing device and method for a multi-channel 3D LiDAR, and more particularly, to a signal processing device and method capable of providing higher resolution than a light receiving sensor having a limited number of channels.

### Description of Related Technology

In general, a multi-channel 3D LiDAR may be classified into a 1D horizontal scanning LiDAR, a 2D vertical and horizontal scanning LiDAR using the same optical system (coaxial structure), and a 1D horizontal scanning and 1D vertical scanning LiDAR using independent optical systems (biaxial structure).

### SUMMARY

One aspect is a device and method for achieving higher resolution than the number of light-receiving sensors (channels).

Another aspect is a signal processing device and method for a 3D LiDAR that is robust against noise by distinguishing and processing noise separately.

Another aspect is a signal processing device for a multi-channel 3D LiDAR, that may include a plurality of light receiving units each forming a channel; a plurality of read-out circuit units configured to convert each light detection signal of the light receiving units into a digital signal; a plurality of digital signal processors configured to determine and output a state of a channel selection signal according to an output of each of the read-out circuit units; and a filter unit configured to infer a scanning pattern using the channel selection signals of the digital signal processors and to filter out, as noise, light reception information of channels that differ from the scanning pattern.

In an embodiment of the present disclosure, each of the plurality of read-out circuit units may output a high-level signal when light is detected by the corresponding light receiving unit, and each of the plurality of digital signal processors may output a channel selection signal having a value of “1” when the output signal level of the corresponding read-out circuit unit is high.

In an embodiment of the present disclosure, the filter unit may be configured to find channels having a channel selection signal of “1” among a plurality of channel selection signals obtained through scanning; select, as a channel of a current scanning point, a channel located within a preset value from a channel selected at a previous scanning point and store the selected channel in a memory; and repeat the above process for all scanning points to determine the scanning pattern.

In an embodiment of the present disclosure, when there are multiple channels having a channel selection signal of “1” within the preset value, the filter unit may select a channel positioned in the middle as a channel of the current scanning point and stores the selected channel.

In an embodiment of the present disclosure, when only channels having a channel selection signal of “1” outside the preset value are present, the filter unit may determine such channels as noise and filter them out.

In addition, a signal processing method for a multi-channel 3D LiDAR according to another aspect of the present disclosure is performed by a processor, and may include (a) finding information of channels that have received light from scanning results at a current scanning point; (b) checking whether each channel that has received light is within a preset value that defines a positional range relative to a channel stored at a previous scanning point; and (c) determining channels that have received light at positions outside the preset value as channels that have received light caused by noise, and filtering out the same.

In an embodiment of the present disclosure, in step (b), when there are multiple channels that have received light within the preset value, a channel positioned in the middle in the arrangement of the channels that have received light may be stored as the channel of the current scanning point.

The present disclosure can implement higher vertical resolution than the number of light receiving units (channels) by using a digital logic circuit, thereby reducing costs associated with adding channels.

In addition, in a situation where the channel position of a light receiving unit (photodetector, PD) on which reflected light is focused changes in real time due to vertical scanning, the present disclosure can infer a scanning position through signals of the light receiving units, select corresponding channels, and perform data acquisition (DAQ). As a result, filtering for distinguishing noise can be performed during the data acquisition stage, enabling the implementation of a noise-resistant system.

Furthermore, since the present disclosure does not perform channel multiplexing, it is possible to accurately identify the pixel position at which the reflected light is focused.

### BRIEF DESCRIPTION OF THE DRAWINGS

FIG. 1 is a flowchart illustrating light-receiving signal processing of a conventional 3D LiDAR.

FIG. 2 is a block diagram of a signal processing device for a multi-channel 3D LiDAR according to an exemplary embodiment of the present disclosure.

FIGS. 3 and 4 are diagrams illustrating examples of channel selection performed by a digital signal processor.

FIG. 5 is a diagram illustrating improvement of resolution in vertical scanning.

FIG. 6 is a flowchart illustrating a signal processing method according to the present disclosure.

FIG. 7 is a table for explaining the operation of a filter unit.

FIG. 8 is a graph showing results of channel selection at multiple scanning points.

### DETAILED DESCRIPTION

In the case of a 1D horizontal scanning LiDAR, as disclosed in International Publication WO2021007023A1 (published on Jan. 14, 2021, titled “POLARIZATION FILTERING IN LIDAR SYSTEM”), a light detection sensor array having a number of channels corresponding to the vertical resolution is used.

In this case, since the vertical resolution of the LiDAR is determined by the number of sensors in the light detection sensor array, the number of photodetectors (PDs) required increases accordingly to achieve higher resolution.

In contrast, in the case of 2D scanning, a LIDAR including a vertical scanning operation can be implemented to receive light at a PD located at an arbitrary position through the vertical scanning operation, thereby obtaining a 3D image with a higher resolution than the number of PDs. However, this requires the LiDAR system to accurately recognize the scanning position, and in particular, when the scanning position signal is inaccurate or absent in a biaxial structure, additional circuits and compensation methods are needed.

To address this, as disclosed in U.S. Pat. No. 11,372,105 B1 (issued on Jun. 28, 2022, titled “FMCW LiDAR using array waveguide receivers and optical frequency shifting”), a channel multiplexing method is generally employed, in which a multiplexer (MUX) circuit is arranged at the TIA/ADC output stage after the PD array so that a signal generated from any PD among multiple channels is received through a single channel.

However, this approach has a limitation in that it is difficult to accurately identify the light receiving position and scanning position because the PD that received the light cannot be specified for its corresponding channel.

As such, in the conventional LiDAR applying only horizontal scanning, there was a problem in that the vertical resolution of the LiDAR was limited by the number of channels of the photodetector.

In addition, in the case of 2D scanning, when the scanning position signal is inaccurate or absent, channel multiplexing is performed before digital signal processing (DSP), which makes it impossible to determine which channel has received the signal.

Accordingly, in the related art, when photodetectors respond simultaneously across multiple channels, it is difficult to predict the pixel position at which the reflected light is focused. Therefore, it is also difficult to determine whether the received input signal is a normal signal caused by reflected light or a signal caused by noise.

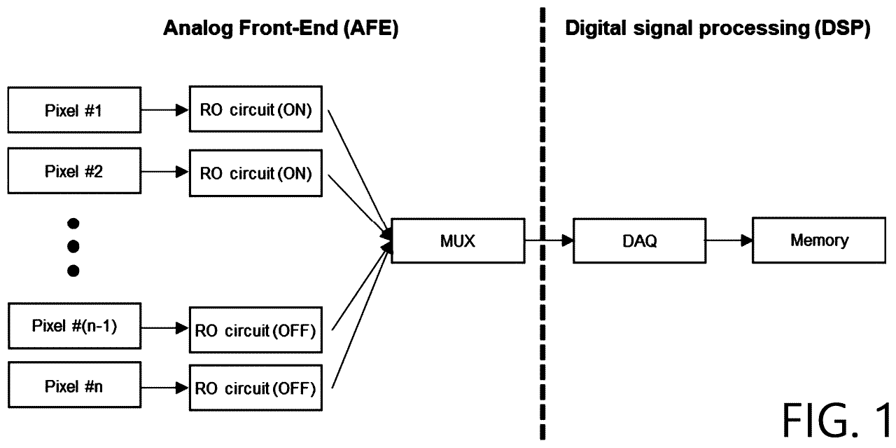

More specifically, FIG. 1 is a flowchart illustrating signal processing of a conventional multi-channel LiDAR.

Referring to FIG. 1, first, in the analog front-end (AFE) processing flow, a read-out (RO) circuit is connected to the output terminal (pixel) of each PD in the multi-channel PD array, and the output of each read-out circuit is connected to a single multiplexer (MUX) circuit. The multiplexer circuit performs a function of collecting the outputs of all PDs and converting them into a single signal, and if any PD responds to reflected light, the signal from that PD becomes the output signal of the MUX circuit.

Subsequently, in digital signal processing (DSP), the data acquisition (DAQ) logic acquires the output signal from the multiplexer and performs signal processing to store the acquired data in memory.

Accordingly, there is a limitation in that it is impossible to determine which channel has received the signal.

In addition, in order to increase the resolution, the number of channels should be continuously increased, which may lead to problems such as increased cost, greater signal processing complexity, and difficulty in establishing countermeasures against the noise described above.

To fully understand the configuration and effects of the present disclosure, exemplary embodiments of the present disclosure will be described with reference to the accompanying drawings. However, the present disclosure is not limited to the embodiments disclosed below and may be implemented in various forms and modified in various ways. Rather, the description of the embodiments is provided to ensure the completeness of the disclosure and to fully convey the scope of the invention to those skilled in the art. In the accompanying drawings, the components are illustrated on an enlarged scale for convenience of explanation, and the proportions of the respective components may be exaggerated or reduced.

The terms “first,” “second,” and the like may be used to describe various components, but the components should not be limited by these terms. Such terms are used only for the purpose of distinguishing one component from another. For example, without departing from the scope of the present disclosure, a “first component” may be referred to as a “second component,” and similarly, the “second component” may be referred to as the “first component.” In addition, unless clearly stated otherwise in the context, the singular forms used herein are intended to include the plural forms as well. The terms used in the embodiments of the present disclosure may be interpreted as having meanings commonly understood by those skilled in the art, unless otherwise defined.

Hereinafter, a signal processing device and method for a multi-channel 3D LIDAR according to an exemplary embodiment of the present disclosure will be described with reference to the drawings.

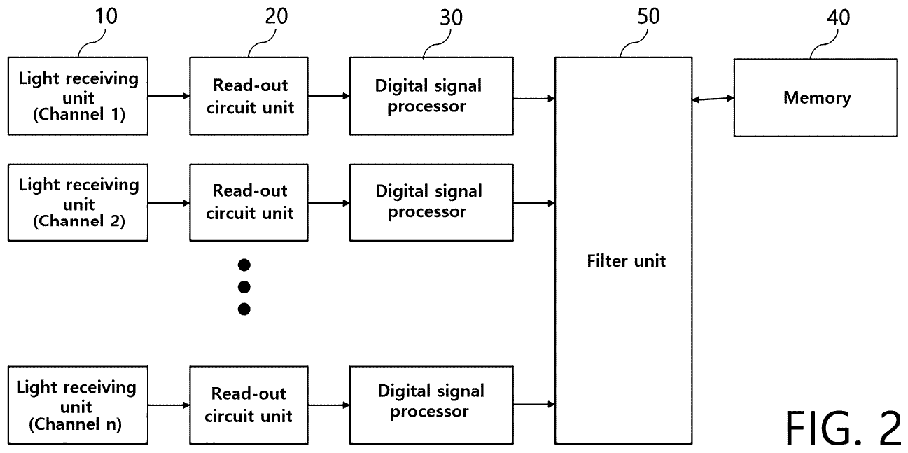

FIG. 2 is a block diagram of a signal processing device for a multi-channel 3D LIDAR according to an exemplary embodiment of the present disclosure.

Referring to FIG. 2, the present disclosure includes a plurality of light receiving units 10 forming a plurality of channels; a read-out circuit unit 20 configured to remove noise from the outputs of the light receiving units 10 and convert the outputs into digital signals; a digital signal processor 30 configured to process the digital signals converted by the read-out circuit unit 20 and output a channel selection signal for each light receiving unit 10 that has received reflected light; a filter unit 50 configured to check the channel selection signal of the digital signal processor 30 and filter out signals determined to be noise when the corresponding channel information deviates from a preset value in comparison with previously stored channel information at a previous scanning point; and a memory 40 configured to store the signals processed by the digital signal processor 30.

Hereinafter, the configuration and operation of the signal processing device for a multi-channel 3D LiDAR according to an exemplary embodiment of the present disclosure will be described in more detail.

In the present disclosure, when light emitted from a light emitting unit is reflected by a scanning target and the reflected light is received by the plurality of light receiving units 10 forming multiple channels, the light receiving units 10 are selectively used to acquire light reception information for each channel.

In addition, the present disclosure is characterized in that a multiplexer (MUX) is not used, and the output signals of all the light receiving units 10 are acquired through respective data acquisition (DAQ) logics of the digital signal processor (DSP) 30.

A plurality of light receiving units 10 are provided to form multiple channels, and each of the light receiving units 10 is connected to a read-out circuit unit 20 that removes noise from the output signal of the light receiving unit 10 and converts the signal into a digital signal.

The read-out circuit unit 20 removes fixed pattern noise inherent to each pixel and converts the noise-removed analog signal into a digital signal.

The output of the read-out circuit unit 20 may be at a high (High) level when reflected light is received by the connected light receiving unit 10, and at a low (Low) level when no reflected light is received.

The output of the read-out circuit unit 20 is not multiplexed and is input to the respective digital signal processor 30 connected thereto.

The digital signal processor 30 has a channel selection function.

That is, the signal of the light receiving unit 10 is processed only when the signal from the read-out circuit unit 20 is at a high level.

The processed result is stored in the memory 40.

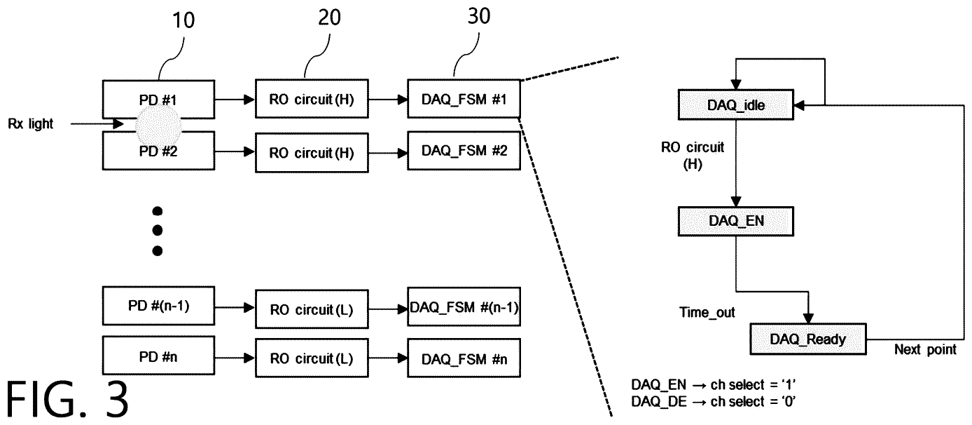

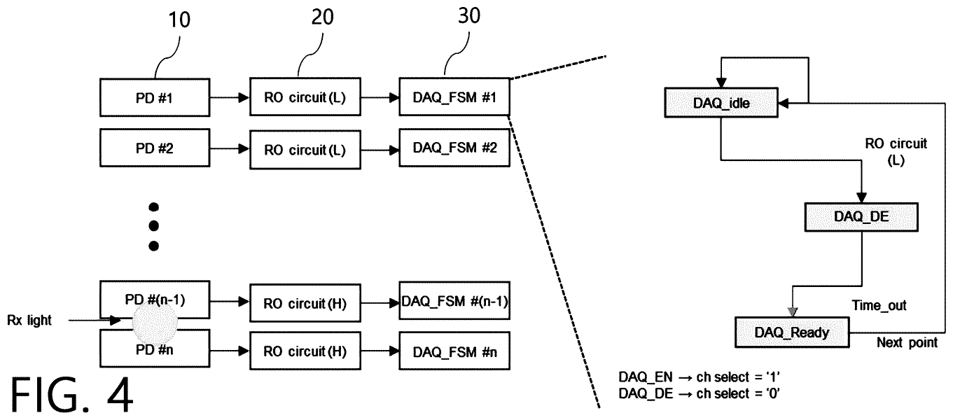

FIGS. 3 and 4 are diagrams illustrating examples of channel selection performed by a digital signal processor 30.

The digital signal processor 30 employs a finite-state machine (FSM) and performs appropriate signal processing by distinguishing between a case in which reflected light is received by the light receiving units 10 (channels 1 and 2 in FIG. 3, and channels n−1 and n in FIG. 4) and a case in which reflected light is not received (channels n−1 and n in FIG. 3, and channels 1 and 2 in FIG. 4).

Referring to FIGS. 3 and 4, the digital signal processor 30 operates in an idle state before receiving a signal from the read-out circuit unit 20, which outputs a high or low signal depending on whether the light receiving unit 10 has received light.

In this case, when the output signal of the read-out circuit unit 20 is high (H), data acquisition is enabled (DAQ_EN). In the data acquisition enabled state, the channel selection signal (ch select) becomes “1,” and after a predetermined period elapses, the processor returns to the idle state through a ready state for the next point.

Conversely, when the output signal of the read-out circuit unit 20 is low (L), data acquisition is disabled (DAQ_DE). In the data acquisition disabled state, the channel selection signal becomes “0,” and thus the corresponding channel is not used. After the predetermined period elapses, the processor passes through the ready state and returns to the idle state.

Accordingly, the digital signal processor 30 can determine whether or not the light receiving unit 10 has received reflected light.

At this point, however, it is not possible to distinguish whether the light received by the light receiving unit 10 is reflected light or noise.

The resolution of a 3D LiDAR image is determined by the product of its horizontal resolution and vertical resolution. Although various methods exist for obtaining high-resolution 3D point cloud images, the present disclosure is applicable to a LIDAR having a multi-channel light receiving unit 10 to which 2D vertical and horizontal scanning is applied.

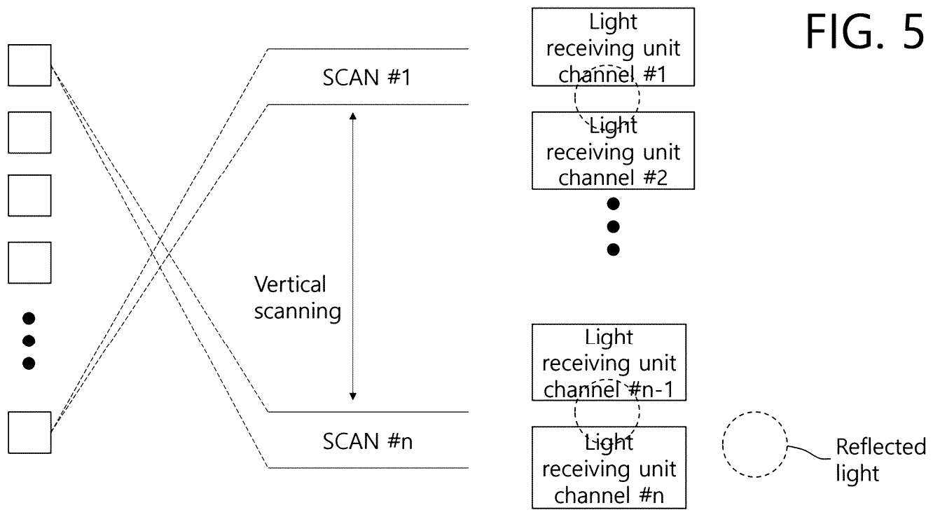

FIG. 5 illustrates that high vertical resolution can be achieved by using a plurality of light receiving units 10 and causing reflected light to be focused on the multi-channel light receiving units 10 through vertical scanning.

Even when the reception area of the reflected light through vertical scanning is smaller than the entire channel (entire light receiving unit) array, time-of-flight (ToF) information can be obtained from the output signal of the light receiving unit 10 on which the reflected light is focused.

In addition, the shorter the laser emission and signal processing cycle during vertical scanning, the higher the vertical resolution that can be achieved.

That is, the present disclosure performs scanning using a plurality of light receiving units 10 and can improve the vertical scanning resolution by distinguishing between a case in which reflected light is received by a single channel (channel 1 or channel 2) and a case in which reflected light is simultaneously received by two adjacent channels (channel 1 and channel 2).

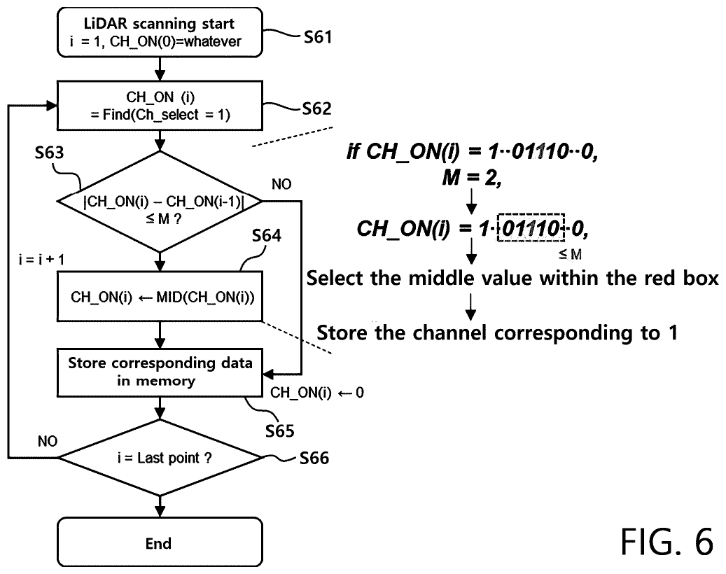

FIG. 6 is a flowchart illustrating a process of determining whether the light received by the light receiving unit 10 is reflected light or noise.

Referring to FIG. 6, the LiDAR scanning starts in step S61.

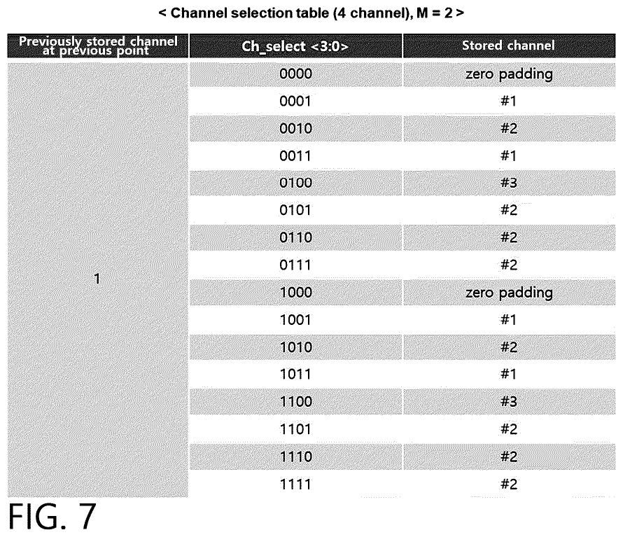

FIG. 7 is a table for explaining the operation of the filter unit 50 and illustrates an example of channel selection in a four-channel LiDAR.

The filter unit 50 may include a processor.

In the case of a four-channel LiDAR using four light receiving units 10, a total of sixteen results can be obtained, ranging from “0000” to “1111.”

The resulting value represents an arrangement of the channel selection signal (ch_selection) values of each digital signal processor 30, where the channels are ordered from the last digit as channel 1, channel 2, channel 3, and channel 4. That is, in the case of “1010,” channel 1 has a channel selection signal of 0, channel 2 has 1, channel 3 has 0, and channel 4 has 1.

As shown in FIG. 6, in step S61, information corresponding to the number of channels can be obtained at a specific scan point (i), and omitted notation is used to represent the multi-channel configuration.

M is a variable value depending on the scanning interval. M is defined as a preset value for finding a channel that is close to the channel point stored at a previous scanning point.

Next, as shown in step S62, to check the channel information (CH_ON(i)) at the current scan point, the channel selection signals having a value of “1” are found from the scanning results, and the information of those channels is stored.

In the above example of “1010,” channel 2 and channel 4 become the channel information (CH_ON(i)).

Next, in step S63, the channel at the current scanning point that is closest to the channel of the previous scanning point is found.

In FIG. 6, CH_ON(i) represents the current channel information and corresponds to the information of the channels whose channel selection signal is “1,” as described above.

In addition, CH_ON(i−1) refers to the channel selected at the previous scanning point, and the term “closest” means the channel having the smallest distance in terms of channel interval.

In FIG. 7, it is assumed that the channel stored at the previous scanning point is channel 1.

That is, in step S63, [CH_ON(i)-CH_ON(i−1)] represents the distance between the channel whose channel selection signal is “1” at the current state and the previously stored channel.

When the preset value (M) is assumed to be 2, it indicates the same channel as the channel stored in the previous state or a channel located one or two positions away in order.

When the preset value (M) is 0, it means that only the same channel as the previous channel can be designated at the current point.

If there is no channel whose channel selection signal is “1” within the range of the preset value (M), zero padding is performed, and the corresponding data is stored in the memory 40 (S65).

In step S64, if there is a channel that satisfies the condition determined in step S63, the corresponding channel is designated as the channel of the current scanning point.

In addition, when there are multiple channels located within the preset value from the previously stored channel that satisfies the condition, the channel positioned in the middle is selected.

FIG. 7 illustrates examples of channels stored according to the scanning results at the current scanning point.

In this case, it is assumed that the channel stored at the previous scanning point is channel 1, and the preset value (M) is 2.

In the case of “0000,” since the channel selection signal is “0” for all channels, zero padding is performed; and in the case of “1000,” since only channel 4 has a channel selection signal of “1,” the distance from the previous channel 1 exceeds 2, and thus the condition of step S63 is not satisfied, so zero padding is also performed.

In the case of “0001,” the same channel as the channel stored in the previous state is selected, and therefore channel 1 (#1) becomes the channel stored at the current scanning point.

In addition, in the case of “0010,” the channel selection signal of channel 2 is “1,” and since the difference from the previously stored channel 1 is 1, which satisfies the preset value (M) range of 2 or less, it is selected and stored as the channel at the current scanning point.

An example of selecting a median value can be illustrated by “0111.” That is, when the channel selection signals of channels 1, 2, and 3 at the current scanning point are all “1,” all the channels 1, 2, and 3 fall within the preset value (M) range of 2, and in this case, the channel having the median value, i.e., channel 2, is stored in the memory 40 as the channel information of the current scanning point (S65).

As shown in step S66, the above steps S62 to S65 are repeated for all scanning points.

Through this process, the present disclosure enables the information of the light receiving unit 10 having an output caused by reflected light to be stored in the memory 40 through channel selection, while removing light reception information caused by noise.

That is, when the channel selected in the previous state and the current channel suddenly deviate from each other, it is determined as light reception caused by noise, and such data can be removed.

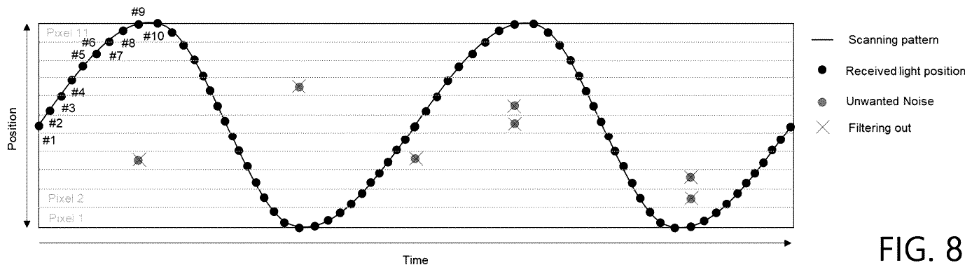

FIG. 8 is a graph showing results of channel selection at multiple scanning points.

As illustrated, when noise occurs that deviates from the scanning pattern, it can be filtered and removed.

In this manner, the present disclosure can infer a scanning pattern through channel selection, and by determining and removing detection results that deviate from the scanning pattern as noise, a more robust LiDAR system can be implemented.

While embodiments according to the present disclosure have been described above, but these are only exemplary, and those of ordinary skill in the art may understand that various modifications and embodiments of equivalent scope are possible therefrom. Accordingly, the true technical protection scope of the present disclosure shall be determined according to the attached claims.

What is claimed is:

1. A signal processing device for a multi-channel 3D LiDAR, the device comprising:
a plurality of light receiving units each forming a channel;
a plurality of read-out circuit units configured to convert each light detection signal of the light receiving units into a digital signal;
a plurality of digital signal processors configured to determine and output a state of a channel selection signal according to an output of each of the read-out circuit units; and
a filter unit configured to infer a scanning pattern using the channel selection signals of the digital signal processors and to filter out, as noise, light reception information of channels that differ from the scanning pattern.

2. The signal processing device for a multi-channel 3D LiDAR according to claim 1,
wherein each of the plurality of read-out circuit units is configured to output a high-level signal in response to light being detected by the corresponding light receiving unit, and
wherein each of the plurality of digital signal processors is configured to output a channel selection signal having a value of “1” in response to the output signal level of the corresponding read-out circuit unit being high.

3. The signal processing device for a multi-channel 3D LiDAR according to claim 2,
wherein the filter unit is configured to:
find channels having a channel selection signal of “1” among a plurality of channel selection signals obtained through scanning;
select, as a channel of a current scanning point, a channel located within a preset value from a channel selected at a previous scanning point and store the selected channel in a memory; and
repeat the above process for all scanning points to determine the scanning pattern.

4. The signal processing device for a multi-channel 3D LiDAR according to claim 3, wherein, in response to there being multiple channels having a channel selection signal of “1” within the preset value, the filter unit is configured to select a channel positioned in the middle as a channel of the current scanning point and stores the selected channel.

5. The signal processing device for a multi-channel 3D LiDAR according to claim 3, wherein, in response to only channels having a channel selection signal of “1” outside the preset value being present, the filter unit is configured to determine such channels as noise and filters them out.

6. A signal processing method for a multi-channel 3D LiDAR, the method being performed by a processor, comprising:
finding information of channels that have received light from scanning results at a current scanning point;
checking whether each channel that has received light is within a preset value that defines a positional range relative to a channel stored at a previous scanning point; and
determining channels that have received light at positions outside the preset value as channels that have received light caused by noise, and filtering out the same.

7. The signal processing method for a multi-channel 3D LiDAR according to claim 6, wherein the checking comprises:
in response to there being multiple channels that have received light within the preset value, storing a channel positioned in the middle in the arrangement of the channels that have received light as the channel of the current scanning point.
